(19) United States
(12) Patent Application Publication
(10) Pub. No.: US 2008/0320087 A1
(43) Pub. Date: Dec. 25, 2008

(54) SWARM SENSING AND ACTUATING

(75) Inventors: Eric J. Horvitz, Kirkland, WA (US); Feng Zhao, Issaquah, WA (US); Aman Kansal, Issaquah, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/767,140

(22) Filed: Jun. 22, 2007

(51) Int. Cl. G06F 15/16

(52) U.S. Cl. 709/206

(57) ABSTRACT

Sensing information from a multitude of remote sources can provide a user with a vast amount of information as well as a better granularity of the information. A user can also actuate or move remote sources to obtain the desired information or more information and/or to expend energy in a remote location with one or more of the remote sources. Thus, a swarm or large group of devices, sensors, actuators, equipment, and so on can be utilized to provide a user with a desired action.

### BACKGROUND

Computing devices are commonly utilized by users to communicate almost instantaneously with one or more contacts. Such information exchange can occur by a user entering information (e.g., text, visual, audio, and so on) into a display area of a user device and communicating with the one or more contacts in a back-and-forth manner without using a telephone or other method of communication. This almost instantaneous communication allows a user and various contacts in disparate locations to communicate in a real time fashion.

In addition, there are a variety of distributed data sources (e.g., cameras, microphones, sensors, equipment, and so on) that can share data over a network, such as the Internet. Such data sources can be utilized to capture data or events occurring where such data source is located. For example, a stationary camera can obtain a picture of the object that it is viewing. These data sources might also have other functions associated therewith. For example, the camera could be rotated so that its view angle captures another picture or a series of pictures. However, such devices, operating alone, might not be able to provide enough data for several applications and a user is limited to the capabilities (e.g., resolution) of the particular device.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with remote swarm sensing and actuating based on a request. Remote swarm sensing can be utilized to obtain information from a multitude of sources (e.g., sensors, actuators, devices, and so on) and combine the information received to provide a requestor with more useful information in a dynamic manner. Remote swarm actuating can allow a requestor to move remote objects, such as a camera, or to cause an object to be moved by remote sources.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system that facilitates obtaining remote swarm sensing and/or actuating a remote object.

FIG. 2 illustrates a system that can carry out a request utilizing one or more remote objects.

FIG. 3 illustrates a system that recognizes and monitors remote sources that can be utilized to implement a request.

FIG. 4 illustrates a system that implements a cost-benefit scheme for implementing a remote action through a wireless network.

FIG. 5 illustrates a system that obtains remote information and/or controls a remote object utilizing a machine learning and reasoning component.

FIG. 6 illustrates a method for obtaining swarm sensing or swarm actuating to comply with a request.

FIG. 7 illustrates a method for identifying and registering remote sources that can be utilized for swarm sensing and actuating.

FIG. 8 illustrates a method for selectively implementing a remote action.

FIG. 9 illustrates a block diagram of a computer operable to execute the disclosed embodiments.

FIG. 10 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

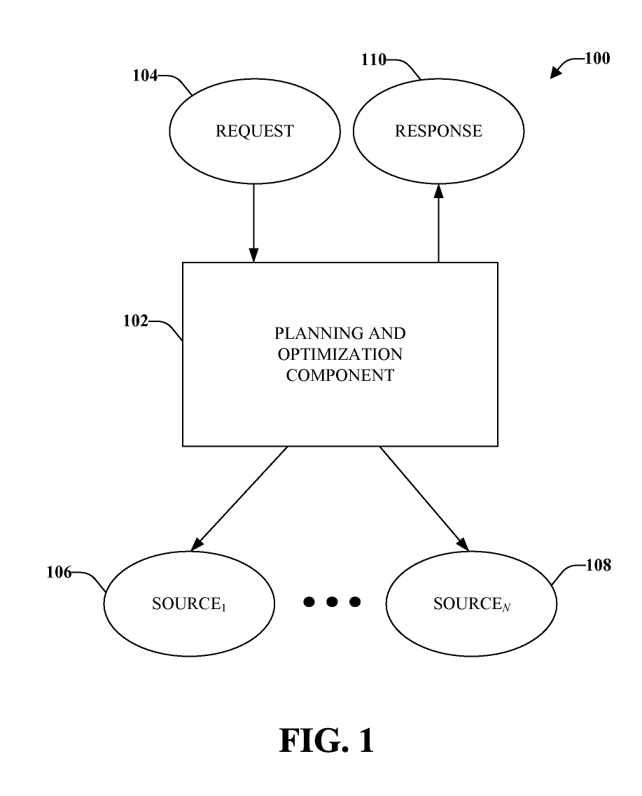

Referring initially to FIG. 1, illustrated is a system 100 that facilitates obtaining remote swarm sensing and/or actuating a remote object. System 100 can be implemented on a network whereby mobile cameras, microphones, sensors and other devices or sources can capture or seek requested information. System 100 can further utilize actuators, sensors, and so forth to take necessary action, as the situation demands or as requested. System 100 can implement anything that an individual (or group) wants to have happen on his behalf or on behalf of a crowd (e.g., banking services, investment services, and so on).

In further detail, system 100 includes a planning and optimization component 102 that can be configured to receive a request 104 from a user and/or entity (e.g., the Internet, another system, a computer and so forth), hereinafter referred to as requester (or alternatively user). The request 104 can be a request for information or a request to implement a remote action. For example, the request 104 can be to obtain a rich view or imagery of a particular location (e.g., Times Square at 1:07 p.m. today). Another example of a request 104 can be for kinetic energy to be expended in a certain location (e.g., move an object, cause an action to occur).

The optimization component 102 can coordinate implementation of the request 104 through one or more remote sources (referred to as swarm sensing), labeled Source₁ 106 through Source_{N} 108, where N is an integer equal to or greater than one. The remote sources can include, but are not limited to, a user device (e.g., cellular phone, computer, microphone, electronic device, etc.), a sensor (e.g., thermometer, heat sensor, photo-eye, weather detector, medical instrument and so forth) and/or equipment (e.g., automobile, earth-moving machinery, farm machinery, robot, construction machinery, and so on), or combinations thereof.

The optimization component 102 can include a database or other means of maintaining information associated with the sources 106, 108 and/or a requestor. As such, the optimization component 102 can be configured to determine which source(s) to utilize for a particular request or to ascertain a cost associated with utilizing a particular source 106, 108. Such maintained information can include identifying the sources 106, 108 (e.g., type, unique identifier, owner of the source), the type of information and/or action each source 106, 108 can provide, the reliability of each source 106, 108 (e.g., correctness of response provided, timeliness, quality, and so on), ranking of each source 106, 108 as submitted by a requestor that received a response or a portion of a response from a particular source, etc.

The request 104 might be implemented or coordinated by the optimization component 102 based on a rate or fee associated with such action. A requestor would purchase the information or the action based on various criteria including the type of action requested, the number of sources needed for the request, the quality of the request, the due date/time to fulfill the request, and other criteria. In some embodiments, the requestor would make the request 104 and the optimization component 102 would query one or more sources 106, 108 to make a determination whether the request 104 can be fulfilled, a rate associated with implementing the request or whether more detail or information is needed to fulfill the request 104. The optimization component 102 may further be configured to allow the owner of the sources 106, 108 to receive compensation (e.g., money, services, or other compensation) for fulfilling the request or at least a sub-portion of the request. In some embodiments, the sources 106, 108 can bid on satisfying the request and the winner of the bid would be notified to satisfy the request (and receive compensation). In other embodiments, pricing might change based on an actual time that the sensing or effecting resource is required. A planner can review pricing over time and can consider either deterministic or probabilistic pricing information in deciding on when to request sensing and effecting resources based on pricing and needs.

A response 110 can be sent to the requestor that includes the requested information (e.g., photo imagery from or video from a camera, audio from one or more microphones, and so forth), confirmation of the completed action (e.g., movement of an object such as moving a large piece of concrete from one location to another location through a combination of humans, vehicles and robotic resources) or combinations (e.g., moving a camera orientation or zoom and then accessing the image available from this requested viewpoint), pricing associated with the request, notification that the request 104 cannot be executed, or another response associated with the request 102 (e.g., refusal to carry out the request, reliability of the response, reliability of the source, and so on).

The request 104 might be accomplished based on various tradeoffs, which can be determined or dictated by the requester and/or inferred by system 100. Tradeoffs can include low-resolution or low quality for an inexpensive response; higher quality or higher-resolution for a more expensive response, high probability of damage to an object for an inexpensive rate; low probability of damage to an object for a more expensive rate, and so forth. As such, the requester might be able to obtain the request while keeping to budget or other constraints.

Thus, system 100 can implement a request anywhere desired by a requester, provided there is a source available to fulfill the request. System 100 can create a mobile Internet or network by replacing a cell phone tower through implementation of one or more sources. Based on demand and resources, requesters can obtain and share information and/or actuate an object.

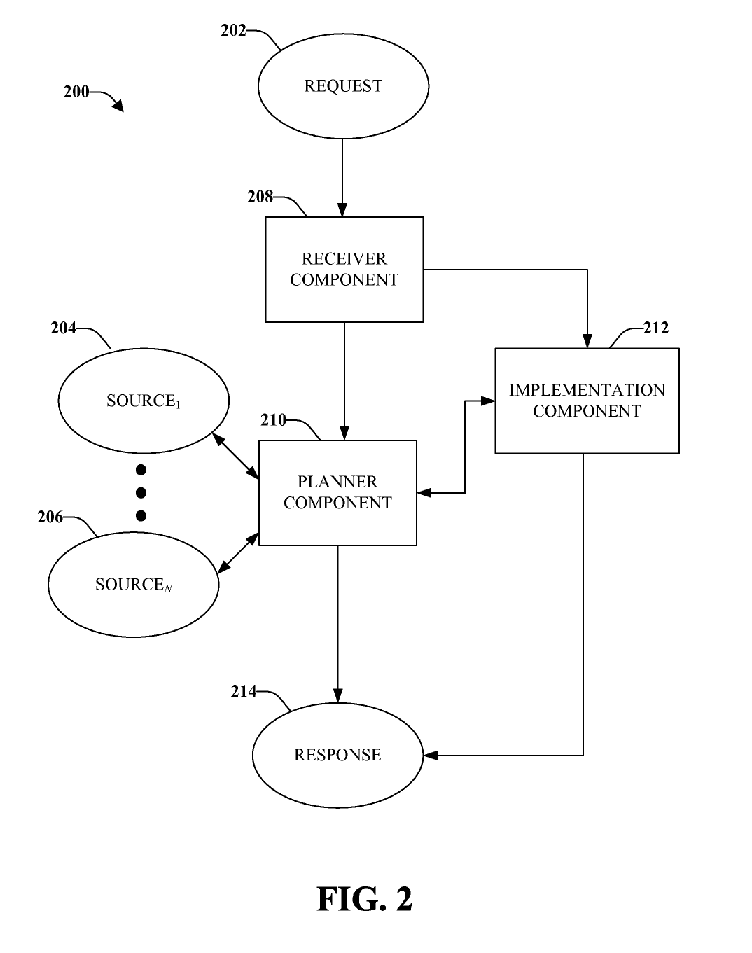

FIG. 2 illustrates a system 200 that can carry out a request utilizing one or more remote sources. System 200 can be configured to selectively accept (or deny) various requests 204 from subscribed users (e.g., users allowed to use the service and/or users that will pay for the service). For example, system 200 can deny the service if the user will not accept various terms and conditions, does not provide a verifiable compensation source (e.g., credit card number, debit card number, bank account, and so forth), misuses the service, requests an action not provided by the service (e.g., illegal in the requested location, scandalous, deemed not acceptable) and/or based on other factors. If the request 202 is accepted by system 200, various remote sources (labeled Source₁ 204 through Source_{N} 206, where N is an integer equal to or greater than one) can be utilized to carry out the request.

System 200 can receive a request to sense information or actuate an object through a receiver component 208 that can be configured to evaluate the request and determine whether the request should be accepted or denied, as discussed above. Receiver component 208 can also facilitate signing up a new user for the service or performing other actions relating the receiving the request.

Receiver component 208 can interface with a planner component 210 and/or an implementation component 212 that, separately or in combination, can be configured to design, coordinate and execute the various actions necessary to carry out the request 202. Implementation component 212 can further be configured to apply one or more actions to selected remote sources in order to implement the received request. Planner component 210 can be configured to decode a query or request to ascertain not only what is being requested but also how to carry out that request. Thus, planner component 210 can determine a plan that utilizes at least one remote source to execute the received request. The requests can be received in various forms (e.g., natural language) to allow the requestor to specify what is requested in a clear manner. Planner component 210 can generate multiple plans through a search or through other optimization methods.

For example, a request is received to listen and clearly hear sounds in a stadium of a sporting event currently in process. With proper analysis and enough microphones (e.g., cell phones, stationary security devices, and so on), a phase array microphone can be built by capturing and merging the audible information from each microphone, even though each microphone might be a low resolution device. The owners of the microphones might be paid to allow system 200 to listen through the device during the entire sporting event (or a sub-portion of the event). For example, the owners might be paid per hour (e.g., twenty-five cents, two dollars) to simply have the device capturing the sounds and submitting the sound data to a server for compilation of the data. System 200 might request the users to aim the microphones in a wave-like or other manner to create a phased array microphone or to achieve a high-resolution sound.

In another example, a request can be to move a four-ton piece of concrete that is sitting in front of a hotel under construction. The request might further indicate that this action should occur before 3:17 P.M. Pacific Time. The planner component 210 can be configured to determine one or more remote sources 204, 206 that can carry out this task from the many sources that are available. The remote sources 204, 206 might be similar sources (e.g., cranes) or different sources (e.g., a crane, a truck-lift, a helicopter utilizing straps and lifting hooks). The planner component 210 might determine that massive moving carts employing solenoids and hydraulics are needed and such moving carts are operated by human operators. For example, the planner component 210 might determine that one corner can be lifted by an available robot that can accept commands directly from the planner component 210. Two other corners might be lifted by human operated devices that do not communicate with robotic systems and the fourth corner can be lifted by an ad-hoc hydraulic system or other source that can be used for this situation.

If the planner component 210 can design and coordinate the particular request (e.g., designed the plan and obtained consent/acceptance by the remote sources), a response 214 can be sent to the requester indicating that the request can be fulfilled. The response 214 might include a cost of implementing such requested action (e.g., $1,012 to move concrete 4 feet) or for obtaining various information (e.g., audio, visual and so forth). The requester can be provided the opportunity to accept or deny the proposed price. In some embodiments, system 200 automatically implements the request if it is determined that the request can be carried out. If the planner component 210 cannot achieve a feasible plan to carry out the request, the response 214 might include the failure of the request. The response 214 might also include an alternative, if there is one available (e.g., the concrete can be moved by 6:17 p.m., four feet would place the concrete in the street but five feet is acceptable).

If the user accepts the response and/or the alternative plan, implementation component 216 can obtain the design from planner component 212 and proceed to implement the plan by selectively applying the at least one action to sense the information or actuate the remote object. Implementation component 216 can communicate directly with the remote sources 204, 204 or might communicate through planner component 212, as shown. Implementation component 216 can communicate the response 214 (e.g., audio, visual, movement of the object) to the user at substantially the same time as the request is completed or after the request is completed. In some embodiments, implementation component 216 can provide status reports for the project (e.g., three sources are available to move the concrete, the concrete has been moved two feet, imagery from 2,317 devices has been obtained and is being merged).

By way of example and not limitation, system 200 can regulate traffic on a highway. If a backup or other event is detected, system 200 can deliver a message to individual cars to improve the traffic flow. Such information can include a different driving route or for the cars to merge to one lane, or other information.

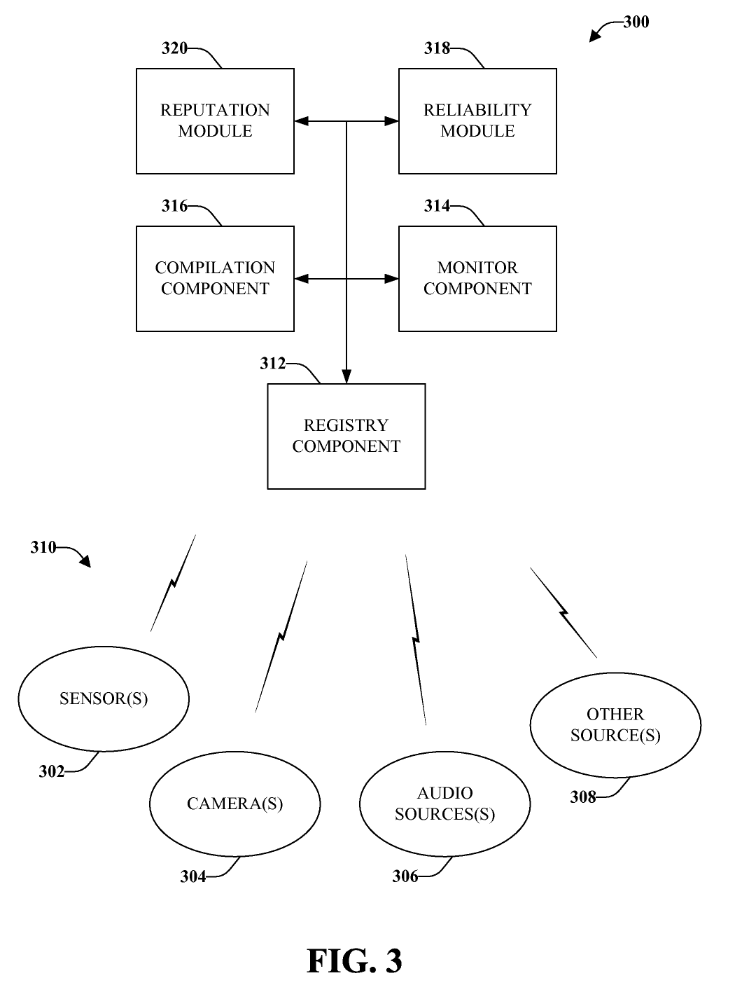

FIG. 3 illustrates a system 300 that recognizes and monitors remote sources that can be utilized to implement a request. Such requests can be simple requests to take a picture of a person, place or thing at a particular moment and place, to obtain auditory information from a place (e.g., stadium, park, zoo, street corner, and so on). Requests that are more complex can include moving objects, distributing products, directing traffic or causing other events to occur.

System 300 can implement such requests from a vast number and variety of sources, which can include sensor(s) or indicator(s) 302. Sensor(s) or indicator(s) 302 can obtain various information including, but not limited to, biometrics sensors, thermometer, barometric pressure, moisture levels, weather indicators, crowd indicators, purchase information indicators, lighting indicator, temperature indicators, noise indicators, pollution indicators, political views in the form of votes (e.g., filtered or revealed), opinions, blood pressure, as well as other sensors and/or indicators. Other sources that can be utilized by system 300 to fulfill a request can include camera(s) 304, audio source(s) 306 (e.g., microphones, loudspeakers, and the like), as well as other source(s) 308 (e.g., remote controlled devices, machinery, equipment, electronic devices, and so forth).

The multitude of sources (labeled collectively as 310) can be in disparate locations and can be located anywhere on the earth (e.g., in a building, home, store or other structure, outside in a yard, park, street or other place, etc.) or in space (e.g., satellite, moon, shuttle, other planets, objects or places). As such, there can be a vast number of sources that should be recognized, monitored and utilized by system 300 in order to carry out the various requests that might be received.

To perform such tasks, system 300 can include a registry component 312 that can be configured to solicit and obtain confirmation from the various sources 310 (e.g., through an owner, controller or other authorized user) that at least some types of information or actions will be provided. For example, the owner of a device, such as a microphone, might be willing to collect audio information from a sporting event, but is not willing to collect audio information from a patent disclosure meeting. In another example, an owner of a backhoe might be willing to allow the backhoe to excavate abandoned property but not to dig up a city street. Limitations can also be automatically established by the system 300 so that various illegal, undesirable, immoral or other specific actions are not caused by a particular request.

Registry component 312 can maintain information associated with each disparate source 310. Such information includes identification of the source (e.g., location of the source whether stationary or mobile, identification of the source, such as an IP address or other contacting and identifying means). Other information can include the type of information (e.g., audio, imagery) and/or services (e.g., moving objects, controlling objects, seeking objects) that can be provided by the source. Such information can be inferred by the identification of the source. For example, source identification might categorize the source as a cell phone and system 300 can infer that this particular source cannot lift a heavy object. Still further information can include a promised viewpoint, resolution, whether an image will be in color or black and white, zoom status, and so forth.

Also included in system 300 can be a monitor component 314 that can be configured to monitor or track the multitude of sources 310. Such monitoring can include ascertaining whether a particular source is available (and willing) to provide information/actions upon request. Over time a source might become damaged or malfunction and is no longer able to perform a requested function or an owner might decide that participation is no longer desired. Monitor component 314 can periodically query the sources 310 to ascertain if the source is available and able to participate. For example, if a loved one is in danger, with a GPS coordinate or other locating means, the closest available device can be queried and the loved one found (or photographed).

If the source is not available (e.g., does not respond after a number of requests), monitor component 314 can notify registry component 312 that the particular source should be removed from a listing of available sources, flagged as inactive, or another action performed. As such, when a request is received for information/action, time will not be wasted attempting to contact a source that has been determined by monitor component 314 to no longer be available to satisfy a request, thus, maintaining a level of system 300 integrity.

In some embodiments, monitor component 314 and/or registry component 312 can query registered sources 310 about other sources within the vicinity that might be a viable source that can be utilized by system. The queried source 310 can query devices that it detects within its vicinity and invite such a source to communicate with system 300 components. As such, system 300 can maintain updated sources while expanding the number of sources to provide rich information and/or performance to fulfill a request.

When a request is received, compilation component 316 can gather a listing of potential sources 310 that can carry out the request. Thus, compilation component 316 can be configured to identify the potential sources and query such sources on their interest in fulfilling the request. For example, to obtain a rich view of a particular place (e.g., Times Square in New York City), a system component 312, 314, 316 can query registered devices within this area, which can be determined through a GPS or other locating means for mobile sources, or directly to stationary sources located in the area. Thus, when a user registers with a swarm sensing network, the user might receive a query periodically, or at certain times as specified as allowed by the user, requesting certain information (e.g., hold your camera up and point to the South). Based on the location information that is published by the device, the device can be utilized to carry out the requests of others.

Users of such registered devices can be any variety of people, such as a journalist with a camera, a student with a camera-phone or a stationary surveillance camera. Each registered device can have metadata in XML format (or in other formats) to communicate which direction it is facing or looking and its position. Other information such as resolution and mobility of the camera can also be obtained from the source or based on data in registry component 312 (e.g., such as for a stationary device). Each device (owner) can charge a fee (e.g., twenty-five cents, fifty-cents, one minute free service, other compensation) to take a picture and upload the picture to a server. From the perspective of the student, her phone can buzz or ring and ask (e.g., text message, automated voice call, etc.) her to take a picture of a certain direction or item (e.g., person, object, and so forth).

However, to obtain a rich picture of the area, more than one source should provide the requested picture or should be used to carry out a particular request. Thus, compilation component 316 can be configured to obtain the picture (continuing the above example) from a multitude of sources (e.g., 50, 5,000 or more individual pictures) and assemble the individual pictures into a rich, high-quality image of Times Square. Such actions are performed seamlessly and should be transparent to the requestor.

A reliability module 318 can be configured to ascertain the reliability of each source 310 and might operate separately or in conjunction with a ranking module 320. Such ranking and reliability measurements can be utilized by the system 300 components to make a determination whether a particular remote source 310 should be utilized. Such rankings or measurements can verify whether a particular source 310 is trusted.

Reliability module 318 can obtain a reliability score or efficiency score based on historical data or other data that can be maintained by a third party service, for example. The reliability signal might be included in a signal received from the source (e.g., the source has obtained reliability measurements from other devices and provides the score in conjunction with means to verify the score.)

The ranking module 320 can compare the requests made from a particular source 310 with the result obtained from the source 310 or with the implementation results of the received request. Ranking module 320 can further assign a quality of service ranking to various remote sources. For example, a high resolution photograph is requested and the source returns a photograph having a very low resolution. Ranking module 320 can determine this and rank the source accordingly, such as by giving the source a low score. If however, a photograph having a much higher resolution (or the same resolution) as that requested was returned, the source might be given a good reliability score. Thus, the reliability signal might be determined or learned by system 300 over time based on historical data. Other factors that can be used for a reliability score or determination are the timeliness of the response and/or a ranking provided by users of the system. For example, the source 310 might be requested to obtain a photograph while facing the West. If a photograph is received facing the East, the requestor might give the source a low ranking.

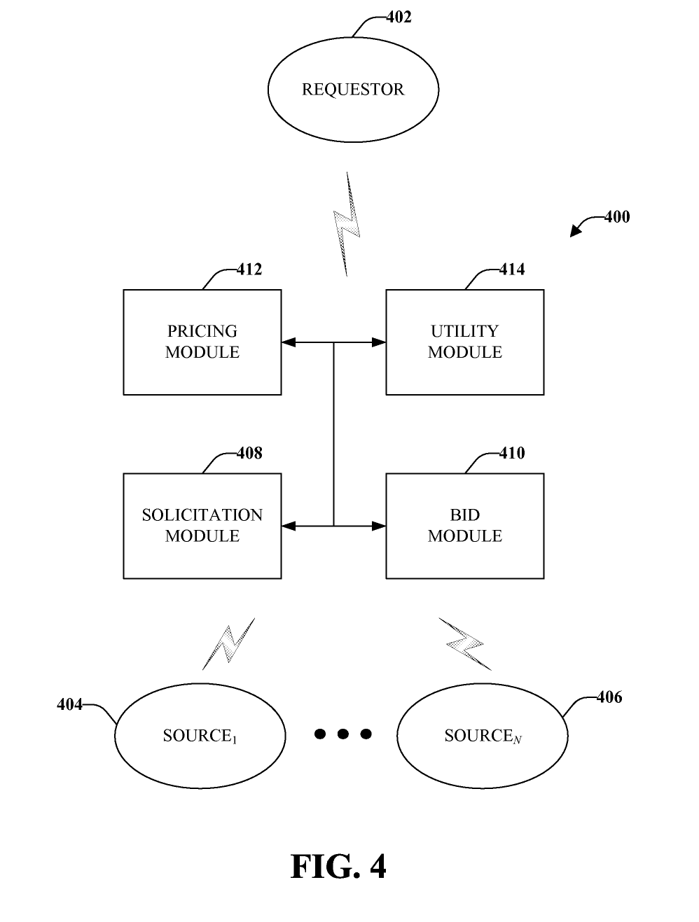

Other factors may be utilized to determine the sources that should be utilized or whether it is cost-effective for the requester to obtain the information or carry out the desired action. FIG. 4 illustrates a system 400 that implements a cost-benefit scheme for selectively implementing a remote action through a wireless network.

System 400 can be configured to receive a request from a requester 402 (e.g., information request, request to perform an action, and so forth) that is to be carried out or implemented by one or more remote sources, illustrated as Source₁ 404 through Source_{N} 406. Both the requestor 402 and the sources 404 might be previously registered with one or more services that provide the various embodiments presented herein. For example, a requestor 402 might request information in some situations. In other situations, requestor 402 might be utilized as a remote source 404, 406.

When a request is received, one or more remote sources 404, 406 that might be able to service the request can be identified and a solicitation module 408 can seek from each of these identified sources 404, 406 whether it is available and willing to assist. A bid module 410 can invite each source 404, 406, successfully recruited by solicitation module 410, to bid or indicate the fee associated with such source 404, 406 performing the request. Bid module 410 can be configured to perform as an auction whereby the lowest bidder, or second lowest bidder, etc. “wins” the bid and can receive compensation for carrying out the request.

Also included in system 400 can be a pricing module 412 that can be configured to determine a price for implementing a request. Such pricing can be based on how the remote source can be manipulated. For example, a camera might provide a picture for fifty-cents. However for another dollar, the camera can be moved (through a remote command) to a particular view point. Other views can be obtained, provided the camera has indicated the range of views and the range of view statuses. Thus, not just the model of what the camera views is published but also the ability to affect the camera and/or move it in the world and view different things with it.

Crowds or individuals might compete for sensors (or other remote sources). For example, if there is a sporting event and teams from different states are playing, the attendees for each respective team might compete for remote sources. Each group of attendees might be competing to obtain a different view of the field (e.g., the view most favorable to their team). The group that submits the highest bid (e.g., pays the most) might get the resources.

A utility module 414 can be configured to analyze preference trade-offs, such as low quality for a low cost, high quality for a high cost, of implementing the received request. Thus, utility module 414 can analyze alternative plans with expected utility considering the costs required to create the plan and the overall value provided by the plan. There might be a probability of damaging something during a move or actuation with a certain plan, however, if the user pays more, system 400 might be able to obtain higher quality machines to move something automatically. The probability of damage can be mitigated, however it might be more expensive. Such tradeoffs can be automatically inferred by utility module 414 based on the benefits of obtaining more reliability or high quality at the higher price. In some embodiments, the requestor is provided the cost-benefit analysis and makes a decision of how to proceed.

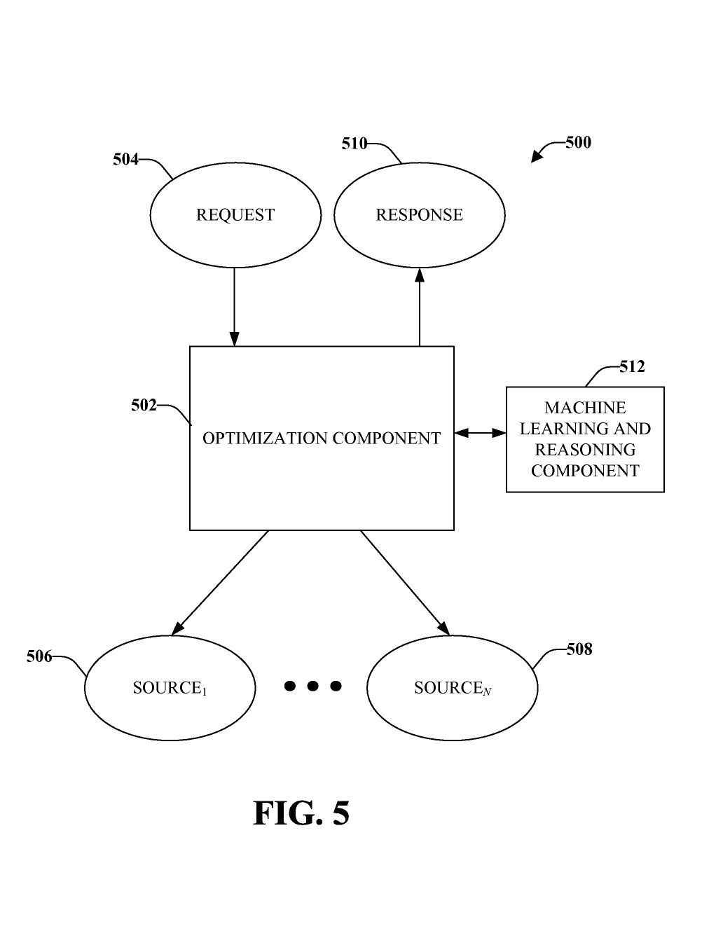

FIG. 5 illustrates a system 500 that obtains remote information and/or controls a remote object utilizing a machine learning and reasoning component. The various embodiments (e.g., in connection with swarm sensing and actuating) can employ various machine learning components (e.g., AI-based schemes, rules based schemes) for carrying out various aspects thereof. For example, a process for determining if a particular source should be used to carry out a particular request can be facilitated through an automatic classifier system and process. Moreover, where multiple sources are employed having the same or similar resources, the classifier can be employed to determine which source to employ in a particular situation.

For example, a request might be received to obtain average temperatures across a certain region. Through utilization of the location of various registered temperature sensing devices (e.g., fixed devices) a query can be made for a temperature reading from each device. Thus, an average cost for utilizing the many devices can be evaluated to determine if an average temperature across the region can be solicited based on certain cost schemes and cost-benefit analysis.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of remote sources systems, for example, attributes can be location, type of services provided by the source, (e.g., microphone, visual, movement), and the classes are categories or areas of interest (e.g., reliability, ranking).

A support vector machine (SVM) is an example of a classifier that can be employed. The SVM operates by finding a hypersurface in the space of possible inputs, such that this hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to grant access, which stored procedure to execute, etc. The criteria can include, but is not limited to, the amount of data or resources to accessed through a call, the type of data, the importance of the data, etc.

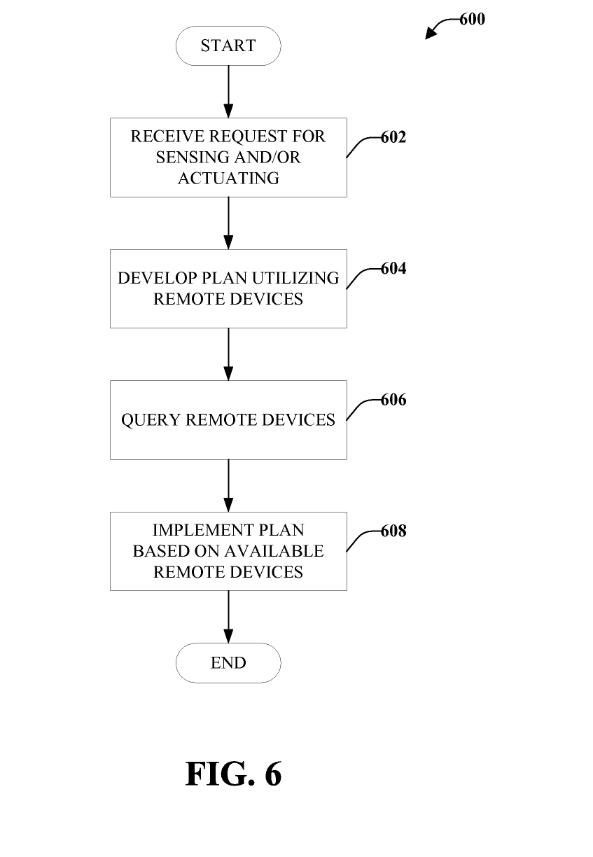

In view of the exemplary systems shown and described above, methodologies that may be implemented in accordance with the disclosed subject matter, will be better appreciated with reference to the flow charts of FIGS. 6-8. While, for purposes of simplicity of explanation, the methodologies are shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 6 illustrates a method 600 for obtaining swarm sensing or swarm actuating to comply with a request. Method 600 starts, at 602, when a request is received. Such a request can relate to sensing remote information (e.g., imagery, sound, and so forth) from a group (or swarm) of people, devices, sensors, actuators, or other objects. The request can also relate to actuating something, such as moving a camera to obtain a 360 degree view of an area, moving an object, and so forth. A requestor could ask for certain kinetic energy to be expended in a certain location, for example, disruptive kinetic energy in the case of military operations or relief distribution in the case of disaster.

At 604, a plan is developed to achieve the sensing and/or actuating from one or more remote sources (e.g., sensors, actuators, devices, equipment, machinery, robots, and so on). Such plan can take into account a requested completion time (e.g., please have the pictures by 3:12 p.m. so I can take them to class tonight). The plan can also take into account the availability and willingness of the remote sources to participant in the plan. At substantially the same time as the plan is developed, the identified remote sources are queried, at 606, to determine which sources can implement the plan. If there are not enough sources available or willing to carry out the plan, method 600 can return to 604 where an alternative plan is developed.

If there are enough remote sources available (and willing) to carry out the plan, the plan is implemented through these devices, at 608. Such plan can be autonomously performed based on the original received request or additional information might be obtained before the plan is implemented. Such addition information can include the price for implementing the plan, whether the requester is willing to pay the requested price, whether the plan can be implemented in a desired time, the expected quality of the results, and so on.

By way of example and not limitation, a request to view an area for the next five minutes at a high resolution to build a 3-dimensional model is received. The goal (view area for time and quality level) is developed into a plan. Resources found on the web and those resources registered with a swarm sensing system are reviewed and it is discovered that there are 10,197 cameras that are relevant and within the area. These cameras are pointing at various parts of the area and a subset of the cameras has the ability to move for different pricing schemes. The view of the area can be pieced together and if there are gaps in the data, other sources can be queried to automatically fill in the gaps to satisfy the resolution goal. Thus, there is some movement and motion of the cameras. This might also need a number of people to be buzzed, called, or solicited as they are walking through the area (as determined by GPS or other locating means) to use their respective devices to take various pictures or video to fill in the gaps.

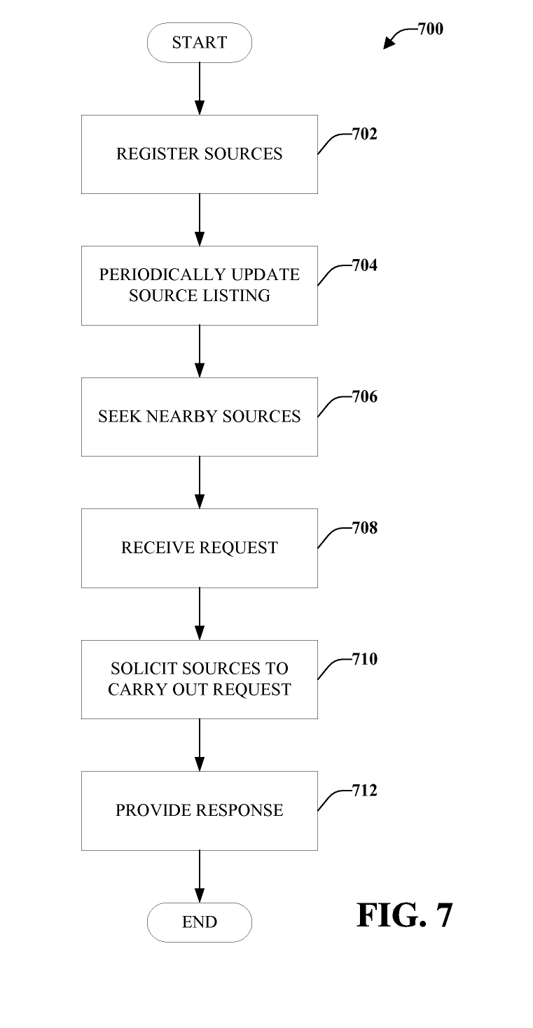

FIG. 7 illustrates a method 700 for identifying and registering remote sources that can be utilized for swarm sensing and actuating. At 702, a multitude of disparate sources are registered and information relating to such sources can be maintained in a database or other storage media. Related information can include a requested price for certain information. For example, a camera might provide a picture for one dollar. However, addition information received from the camera might reveal that for five dollars the view can be purchased for five minutes. For ten dollars, the camera can be moved a certain distance or range of motion and for twenty dollars, a full range of motion is available. Thus, the device broadcasts not just the fact that it can sense something but that it can also be moved (or actuated) remotely.

The source listing can be periodically updated, at 704. Such updating can determine whether a source is defective or is no longer available, for example. If a source is determined to no longer be available, it can be removed from the source listing.

At 706, a query is performed to search for nearby devices. Such a query can be requested at substantially the same time as the source listing is updated or at a different time. A query for nearby devices can reveal other devices that can be utilized to perform sensing and/or actuating in accordance with the disclosed embodiments. This can increase the number of actions that can be performed as well as the granularity of the information received from the remote sources.

A request for sensing and/or actuating is received, at 708. Remote sources identified as potential candidates (e.g., at least a subset of the resources) for carrying out the request are solicited for the requested actions. Such solicitation can allow the potential candidates to accept or reject the request, submit a bid for carrying out the request, or other information.

At 710, a response to the request is provided. Such response can include the sensing information (e.g., picture, sound, and so forth) and/or physical movement of a remote object (e.g., camera movement to obtain different views). As such, remote actuating and sensing can be performed through a group (or swarm) of sources.

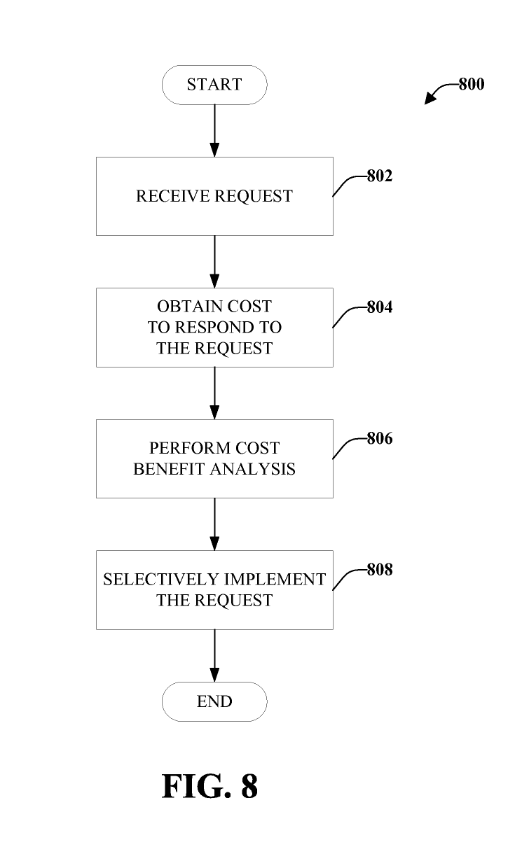

FIG. 8 illustrates a method 800 for selectively implementing a remote action. A request for information (e.g., sensing) or action (e.g., actuating) is received, at 802. The cost of responding to the request is obtained, at 804. Such cost can be obtained from allowing a multitude of remote devices, either individually or as a group to bid on the request.

Based on the cost received a cost-benefit analysis can be performed, at 806. Such cost-benefit analysis can take into account the resolution desired, the amount of safety desired, the amount of reliability desired, and so forth and weigh such facts against the price. If the costs greatly outweigh the benefits, a lower cost solution might be sought or the request might be denied. If the benefits outweigh the costs, the solution might be implemented. Thus, the solution can be selectively implemented, at 808, based in part on the cost-benefit analysis conducted. Such implementation can be performed automatically or the requestor might be queried to make the determination.

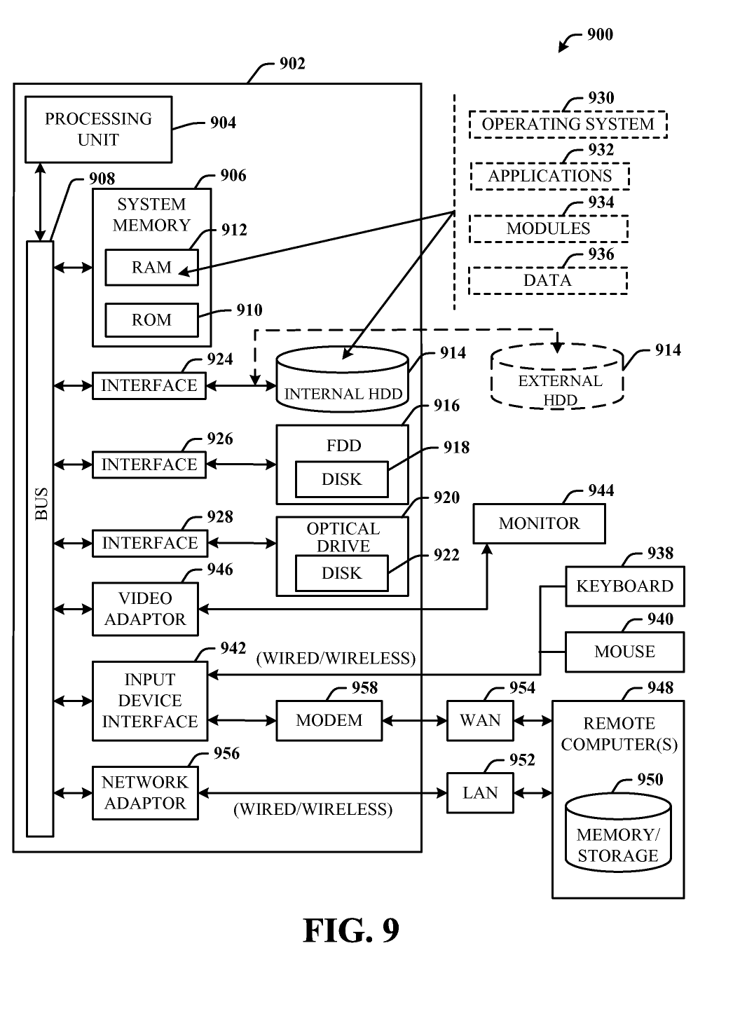

Referring now to FIG. 9, there is illustrated a block diagram of a computer operable to execute the disclosed architecture. In order to provide additional context for various aspects disclosed herein, FIG. 9 and the following discussion are intended to provide a brief, general description of a suitable computing environment 900 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the various embodiments can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

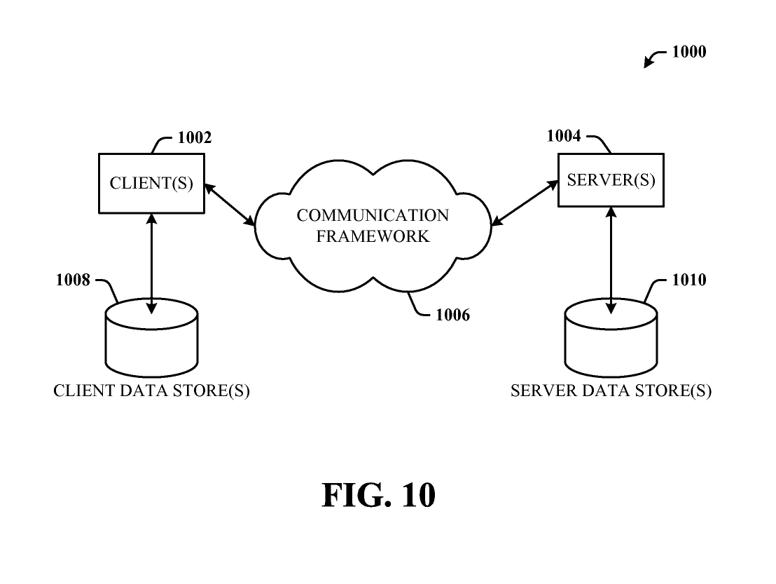

Referring now to FIG. 10, there is illustrated a schematic block diagram of an exemplary computing environment 1000 in accordance with the various embodiments. The system 1000 includes one or more client(s) 1002. The client(s) 1002 can be hardware and/or software (e.g., threads, processes, computing devices). The client(s) 1002 can house cookie(s) and/or associated contextual information by employing the various embodiments, for example.

The system 1000 also includes one or more server(s) 1004. The server(s) 1004 can also be hardware and/or software (e.g., threads, processes, computing devices). The servers 1004 can house threads to perform transformations by employing the various embodiments, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated through a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

What is claimed is:

1. A system that facilitates responding to a request for sensing or actuating through a remote object over a mobile network, comprising:
a receiver component that receives a request to sense information or actuate an object; and
a planner component that determines a plan that utilizes at least one remote source to execute the received request; and
an implementation component that selectively applies one or more actions to selected remote sources in order to implement the received request.

2. The system of claim 1, the remote source is at least one of a sensor, a user device, equipment, or combinations thereof.

3. The system of claim 1, further comprising a registry component that obtains confirmation from the one or more remote sources of one or more type of information or action that the one or more remote sources will provide.

4. The system of claim 1, wherein the receiver component evaluates the request and determines whether the request should be accepted or denied.

5. The system of claim 1, further comprising a registry component that maintains information associated with the one or more remote sources.

6. The system of claim 1, further comprising a monitor component that tracks a plurality of remote sources that include the at least one remote source and determines whether each remote source of the plurality of remote sources is available to provide a requested action.

7. The system of claim 1, further comprising a reliability module that ascertains a reliability of the one or more remote sources.

8. The system of claim 1, further comprising a ranking module that compares the received request with the implementation results of the received request to assign a quality of service ranking to the one or more remote sources.

9. The system of claim 1, further comprising a bid module that invites the one or more remote sources to bid on the received request.

10. The system of claim 1, further comprising a pricing module that determines a price for implementing the received request.

11. The system of claim 1, further comprising a utility module that analyzes preference trade-offs of implementing the received request.

12. A method for identifying remote sources that can be utilized for swarm sensing and actuating
registering a plurality of resources and information associated with the plurality of resources;
periodically updating the registered plurality of resources;
querying for nearby devices; and
updating the registered plurality of resources if a nearby device is detected.

13. The method of claim 12, further comprising:
receiving a request to perform a remote function;
soliciting at least a subset of the plurality of resources to bid on the received request; and
selectively responding to the received request.

14. The method of claim 12, periodically updating the registered plurality of resources comprising determining if one or more of the plurality of resources is defective or no longer available.

15. The method of claim 12, further comprising:
receiving a request to sense or actuate a remote source;
obtaining a cost to respond to the received request;
performing a cost-benefit analysis with the obtained cost; and
selectively implementing the received request based in part on the cost-benefit analysis.

16. The method of claim 15, further comprising determining a lower cost solution if the cost-benefit analysis indicates that the costs outweigh the benefits of implementing the received request.

17. The method of claim 12, further comprising automatically implementing the received request if the benefits outweigh the costs.

18. A computer executable system that provides remote sensing and actuating; comprising:
means for receiving a request to sense or actuate a remote object;
means for creating a plan to implement the received request; and
means for selectively implementing the created plan.

19. The system of claim 18, further comprising:
means for requesting bids to implement the created plan; and
means for accepting at least one bid to implement the created plan.

20. The system of claim 18, further comprising:
means for generating multiple plans through search or another optimization method; and
means for analyzing alternative plans with expected utility considering the costs required to create the plan and the overall value provided by the plan.
